(19) United States
(12) Patent Application Publication
(10) Pub. No.: US 2021/0254691 A1
(43) Pub. Date: Aug. 19, 2021

(54) ELECTRICALLY DRIVEN CYLINDER

(71) Applicant: SINTOKOGIO, LTD., Nagoya-shi, Aichi (JP)

(72) Inventors: Seiichi MURASE, Shinshiro-shi (JP); Yuu ISHIDA, Shinshiro-shi (JP); Takemasa KONDO, Shinshiro-shi (JP)

(73) Assignee: SINTOKOGIO, LTD., Nagoya-shi, Aichi (JP)

(21) Appl. No.: 17/049,502

(22) PCT Filed: Apr. 3, 2019
(86) PCT No.: PCT/JP2019/014858

§ 371 Date: Oct. 21, 2020

(30) Foreign Application Priority Data
Jun. 5, 2018 (JP) 2018-107372

(51) Int. Cl. F16H 25/24; F16H 25/22; F16H 57/04

(52) U.S. Cl. CPC F16H 25/24; F16H 2025/2081; F16H 57/0497; F16H 25/2204

(57) ABSTRACT

An electrically driven cylinder in which the supply of a lubricant is not needed for a long period of time. The electrically driven cylinder, comprising: a screw mechanism portion that converts rotational motion of an electric motor into linear motion; a rod that reciprocates by linear motion of the screw mechanism portion; a bushing member that regulates swinging of the rod; and a key member which is inserted into a rod groove portion provided along an axial direction of the rod and which regulates rotation of the rod; a lubricant being sealed in the screw mechanism portion, the bushing members having a plurality of holes in which a lubricant is embedded, and the key member having a plurality of holes in which a lubricant is embedded.

### TECHNICAL FIELD

The present invention relates to an electrically driven cylinder.

### BACKGROUND

An electrically driven cylinder is conventionally known comprising a motor, a ball screw, and a cylinder capable of reciprocating motion by converting rotational motion of the motor into linear motion by the ball screw.

Patent Document 1, which is one example of the prior art, discloses an electrically driven cylinder comprising a cylindrical cylinder, a rod disposed in the cylinder, a screw mechanism which includes a ball screw and which converts rotational motion of an electric motor into linear motion of the rod, bushing members that suppress swinging of the rod in the cylinder, and a key member that regulates rotation of the rod.

### CITATION LIST

### Patent Literature

Patent Document 1: JP 2012-147605 A

### SUMMARY OF INVENTION

### Technical Problem

However, the features disclosed in Patent Document 1 have a problem in that the routine supply of a lubricant to the bushing members, the key member, and the ball screw is required.

The present invention was made in view of the above, and has the purpose of obtaining an electrically driven cylinder in which the supply of a lubricant is not needed for a long period of time.

### Solution to Problem

The present invention, which solves the problem previously described and achieves the purpose, is an electrically driven cylinder comprising: a screw mechanism portion that converts rotational motion of an electric motor into linear motion; a rod that reciprocates by linear motion of the screw mechanism portion; a bushing member that regulates swinging of the rod; and a key member which is inserted into a rod groove portion provided along an axial direction of the rod and which regulates rotation of the rod, a lubricant being sealed in the screw mechanism portion, the bushing member having a plurality of holes in which a lubricant is embedded, and the key member having a plurality of holes in which a lubricant is embedded.

In the electrically driven cylinder of the present invention with the above-mentioned configuration, it is preferable that the lubricant in the screw mechanism portion is a semi-solid and the lubricants of the bushing member and the key member are solids.

### Effects of Invention

According to the present invention, an effect is provided in which it is possible to eliminate the need to supply a lubricant to an electrically driven cylinder for a long period of time.

### BRIEF DESCRIPTION OF DRAWINGS

FIG. 1 illustrates the external configuration of an electrically driven cylinder according to an embodiment.

FIG. 2 illustrates the internal configuration of the electrically driven cylinder according to the embodiment.

FIG. 3A is a perspective view illustrating the detailed configuration of a strain detecting portion illustrated in FIG. 2.

FIG. 3B is a plan view of the strain detecting portion as viewed in the direction of the arrow illustrated in FIG. 3A.

FIG. 4 illustrates the detailed configuration of a screw mechanism portion illustrated in FIG. 2.

FIG. 5 illustrates the detailed configuration of a bushing member illustrated in FIG. 2.

FIG. 6 illustrates the detailed configuration of a key member illustrated in FIG. 2.

### DESCRIPTION OF EMBODIMENTS

An embodiment of the present invention is described below with reference to the drawings. However, the present invention is not to be construed as being limited by the description of the embodiment below.

### Embodiment

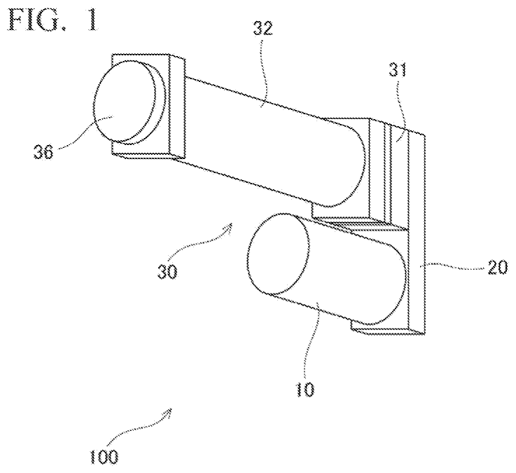

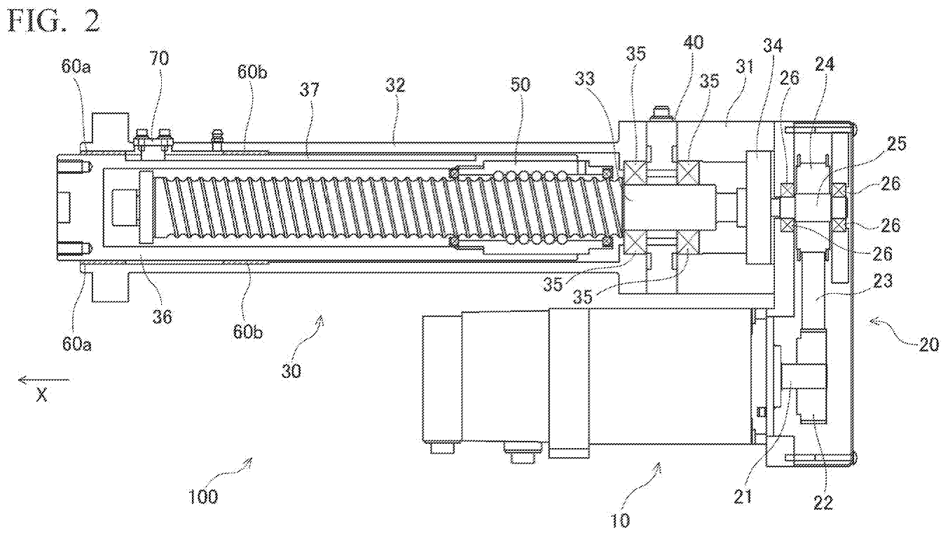

FIG. 1 illustrates the external configuration of an electrically driven cylinder 100 according to the present embodiment. FIG. 2 illustrates the internal configuration of the electrically driven cylinder 100 according to the present embodiment. The electrically driven cylinder 100 illustrated in FIGS. 1 and 2 comprises an electric motor 10, a rotation-transmitting mechanism 20 connected to the electric motor 10, and a cylinder portion 30 connected to the rotation-transmitting mechanism 20. The cylinder portion 30 comprises a first tube portion 31 and a second tube portion 32, and a rod 36 is disposed therein.

The X-axis shown in FIG. 2 defines the outward direction in which the rod 36 exits the cylinder portion 30 as the positive direction and defines the inward direction in which the rod 36 enters the cylinder portion 30 as the negative direction.

The electric motor 10 is a structure for rotationally driving and the operation thereof is controlled by being connected to a control means (not shown) such as a controller. The electric motor 10 is, for example, a servo motor.

The rotation-transmitting mechanism 20 comprises: a second rotary shaft 25 connected to the cylinder portion 30; a plurality of deep groove ball bearings 26 rotatably supporting the second rotary shaft 25; a first timing pulley 22 attached to a first rotary shaft 21, which is an output shaft of the electric motor 10; a second timing pulley 24 attached to the second rotary shaft 25; and a timing belt 23 disposed between the first timing pulley 22 and the second timing pulley 24.

The first rotary shaft 21 transmits rotation of the electric motor 10 to the first timing pulley 22. The timing belt 23 transmits rotation of the first timing pulley 22 to the second timing pulley 24. Rotation of the second timing pulley 24 is transmitted to the second rotary shaft 25. Rotation of the second rotary shaft 25 is transmitted to a third rotary shaft 33 through a reduction gear 34 provided in the cylinder portion 30. The second rotary shaft 25 and the third rotary shaft 33 of the cylinder portion 30 are connected through the reduction gear 34. In this manner, the rotation-transmitting mechanism 20 transmits rotation of the electric motor 10 to the cylinder portion 30.

However, the present invention is not limited thereto. The rotation-transmitting mechanism 20 may comprise a gear and rotation of the electric motor 10 may be transmitted to the cylinder portion 30 by the gear. When a rotary shaft of the electric motor 10 is connected in series to a rotary shaft of the cylinder portion 30, that is, when the second rotary shaft 25 is connected in series to the first rotary shaft 21, the electrically driven cylinder 100 may not be provided with the rotation-transmitting mechanism 20 as previously described and may be provided with a rotation-transmitting mechanism such as a shaft joint (coupling) instead of the rotation-transmitting mechanism 20. In addition, when a rotary shaft of the cylinder portion 30 and a rotary shaft of the electric motor 10 are arranged in series and the rotation-transmitting mechanism 20 is not provided, the rotary shaft of the cylinder portion 30 and the rotary shaft of the electric motor 10 may be directly connected.

The cylinder portion 30 comprises the second tube portion 32 and the first tube portion 31 which has a square tube shape and is disposed between the rotation-transmitting mechanism 20 and the second tube portion 32.

The third rotary shaft 33 is provided so as to extend from the first tube portion 31 to the second tube portion 32 and transmits rotation of the second rotary shaft 25 to a screw mechanism portion 50 of the second tube portion 32. The third rotary shaft 33 is rotatably supported by thrust angular ball bearings 35 fixed inside of the first tube portion 31 and the second tube portion 32.

A strain detecting portion 40 is provided between the first tube portion 31 and the second tube portion 32. The strain detecting portion 40 is provided covering part of the outer circumference of the third rotary shaft 33 and detects a load of the rod 36 by force transmitted from the second tube portion 32. The strain detecting portion 40 is provided at a location where a load in the axial direction applied to the rod 36 is transmitted via the screw mechanism portion 50. Specifically, the strain detecting portion 40 is a rectangular plate-like member held between the first tube portion 31 and the second tube portion 32, which constitute the cylinder portion 30.

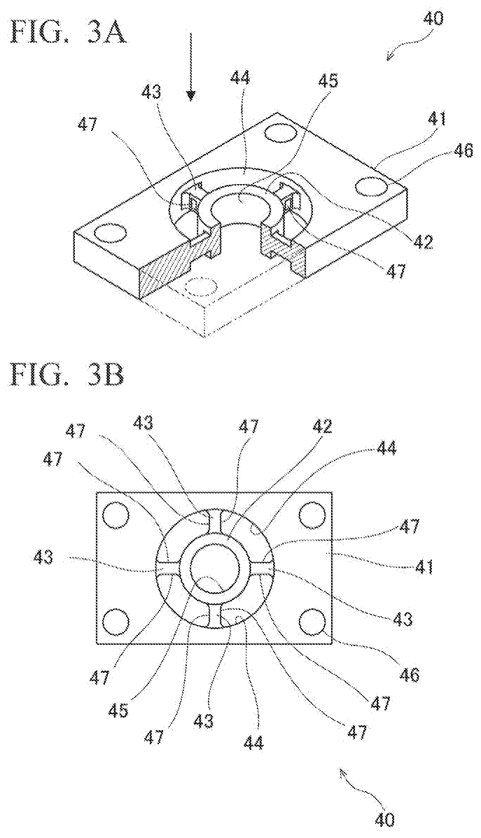

FIG. 3A is a perspective view illustrating the detailed configuration of the strain detecting portion 40 illustrated in FIG. 2. FIG. 3B is a plan view of the strain detecting portion 40 as viewed in the direction of the arrow illustrated in FIG. 3A. In FIG. 3A, the strain detecting portion 40 is shown with a part thereof cut away to clarify the arrangement structure of the members. The strain detecting portion 40 illustrated in FIGS. 3A and 3B is a strain gauge attachment member and has a fixing portion 41 held between the first tube portion 31 and the second tube portion 32 provided on the outer circumference due to a plurality of holes 44, 45 being provided, a load receiving portion 42 provided in the center and receiving a load in the axial direction applied to the rod 36, and sensing portions 43 that are provided between the fixing portion 41 and the load receiving portion 42 and sense a strain.

Holes 46 through which bolts are inserted are provided at the four corners of the strain detecting portion 40. The fixing portion 41 is fixed by the bolts so as to be held between the first tube portion 31 and the second tube portion 32. The load receiving portion 42 provided covering part of the outer circumference of the third rotary shaft 33 receives a load in the thrust direction received by the thrust angular ball bearings 35 of the third rotary shaft 33. Thus, when a load in the axial direction applied to the rod 36 through the thrust angular ball bearings 35 of the third rotary shaft 33 is transmitted, the load receiving portion 42 is deflected and the sensing portions 43 between the fixing portion 41 and the deflected load receiving portion 42 are deformed. Strain gauges 47 are affixed to the sides of the sensing portions 43. The locations where the strain gauges 47 are affixed are not limited thereto and may be the upper surfaces or lower surfaces of the sensing portions 43. By a Wheatstone bridge being formed by the plurality of strain gauges 47, the strain detecting portion 40, which has the plurality of strain gauges 47, outputs a voltage signal proportional to an applied voltage and proportional to a strain. The output of the strain detecting portion 40 is sent to a control means such as a controller. Thus, the strain detecting portion 40 detects a load in the axial direction transmitted from the rod 36 via the screw mechanism portion 50 and outputs an electric signal.

One end of the second tube portion 32 is attached to the first tube portion 31 through the strain detecting portion 40 and the other end thereof is open. The second tube portion 32 comprises the screw mechanism portion 50 attached to the third rotary shaft 33, the rod 36 disposed outside of the screw mechanism portion 50, a bushing member 60a provided on the opening side of the second tube portion 32, a bushing member 60b provided between the screw mechanism portion 50 and the bushing member 60a, and a key member 70 inserted into a rod groove portion 37 provided to the rod 36.

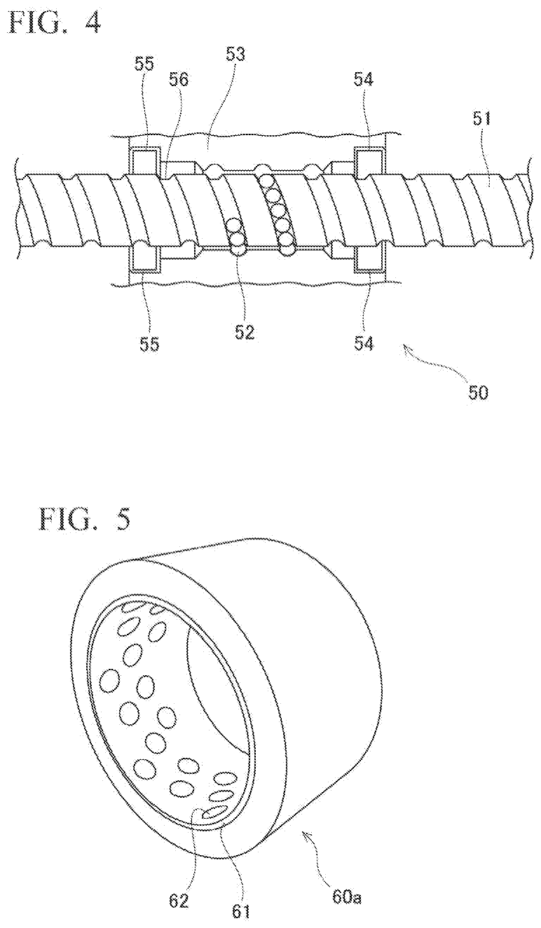

FIG. 4 illustrates the detailed configuration of the screw mechanism portion 50 illustrated in FIG. 2. The screw mechanism portion 50 comprises a ball screw shaft 51, balls 52, a ball screw nut 53, a first seal 54, and a second seal 55, and converts rotational motion of the third rotary shaft 33 into linear motion.

The ball screw shaft 51 is continuously provided from the third rotary shaft 33 and rotates by the third rotary shaft 33. The balls 52 are disposed between the ball screw shaft 51 and the ball screw nut 53 and roll therebetween. The ball screw nut 53 has a through-hole into which the ball screw shaft 51 is inserted and the balls 52 are disposed between the ball screw nut 53 and the screw groove of the ball screw shaft 51.

The first seal 54 is an annular member matching the shape of the ball screw shaft 51, and is in contact with a ball rolling portion 56 of the ball screw shaft 51 at the X-axis negative direction end of the ball screw nut 53 (right side of FIG. 4) to suppress a lubricant sealed in the ball screw nut 53 from leaking out of the ball screw nut 53. The second seal 55 is in contact with the ball rolling portion 56 of the ball screw shaft 51 similarly to the first seal 54 at the X-axis positive direction end of the ball screw nut 53 (left side of FIG. 4) to suppress leakage of the lubricant. In addition, a cover is provided outside of the first seal 54 and the second seal 55, and the seals are fixed by the cover. The lubricant sealed in the ball screw nut 53 is a semi-solid and an example thereof is grease. The present invention is not limited thereto and the lubricant sealed in the ball screw nut 53 may be a solid.

The rod 36 is a columnar member which is screwed into and integrated with the ball screw nut 53 and which reciprocates by linear motion converted from rotational motion in the screw mechanism portion 50. At least one rod groove portion 37 extending in a direction parallel to the direction of reciprocation of the rod 36 is formed in the rod 36.

The bushing member 60a and the bushing member 60b are cylindrical members and are in contact with the rod 36 to prevent swinging of the rod 36 while applying a lubricant to the rod 36.

FIG. 5 illustrates the detailed configuration of the bushing member 60a illustrated in FIG. 2. The bushing member 60a is fitted into the second tube portion 32 by press-fitting. Marginal spacing is formed between the inner surface of the bushing member 60a and the outer surface of the rod 36 so as to enable the rod 36 to slide with respect to the second tube portion 32.

Here, when the bushing member 60a and the bushing member 60b are not provided, there is a risk that the rod 36 will swing. If the rod 36 swings, part of the screw mechanism portion 50 can be worn away and may furthermore result in damage. As illustrated in FIG. 2, the bushing member 60a and the bushing member 60b are spaced from each other and are in contact with the rod 36 at two locations. According to the bushing member 60a and the bushing member 60b as described above, it is possible to suppress swinging of the rod 36.

The bushing member 60a is a cylindrical member having a base material 61 made of a metal and has a plurality of holes 62 in the face in contact with the rod 36 and is formed as a single piece by a solid lubricant being embedded in the plurality of the holes 62. Here, an example of the metal of the base material 61 is a high-strength brass-based alloy and an example of the lubricant is an oil-containing graphite-based solid lubricant. However, the present invention is not limited thereto and the lubricant embedded in the bushing member 60a and the bushing member 60b may be a semi-solid. In addition, because the configuration of the bushing member 60b is the same as that of the bushing member 60a, the description thereof is omitted.

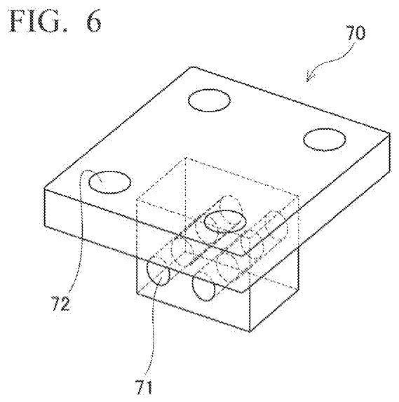

FIG. 6 illustrates the detailed configuration of the key member 70 illustrated in FIG. 2. The key member 70 is a protruding shape. The protruding portion of the key member 70 is inserted into an opening provided in the second tube portion 32 and attached to the second tube portion 32 by a screw member. The protruding portion of the key member 70 inserted into the second tube portion 32 regulates rotation of the rod 36 by engaging the rod groove portion 37. A plurality of holes 71 is provided in the face of the protruding portion of the key member 70 in contact with the rod groove portion 37, a solid lubricant is embedded in the plurality of holes 71, and the protruding portion of the key member 70 and the rod groove portion 37 smoothly slide while being in contact with each other by the linear motion of the rod 36. Holes 72 through which a plurality of bolts is inserted are provided in the upper bottom face of the key member 70 and the key member 70 is fixed to the second tube portion 32 by the bolts that pass through the holes 72. An example of the lubricant embedded in the key member 70 is an oil-containing graphite-based solid lubricant. However, the present invention is not limited thereto and the lubricant embedded in the key member 70 may be a semi-solid.

In addition, because the key member 70 receives torque of the rod 36 and thus requires strength, the base material of the key member 70 is preferably formed from a high-strength brass-based alloy.

Thus, in the electrically driven cylinder 100 illustrated in FIG. 1, because a lubricant is sealed or embedded, it is possible to eliminate the need to supply a lubricant to the screw mechanism portion 50, the bushing member 60a, the bushing member 60b, and the key member 70 for a long period of time.

Therefore, according to the present embodiment, it is possible to eliminate the need to supply a lubricant to an electrically driven cylinder for a long period of time.

In addition, in a conventional electrically driven cylinder, when the direction of reciprocation of the rod is the direction of gravity, that is, when the rod moves up and down, the lubricating oil easily leaks from the rod and the lubricating oil may adhere to the workpiece. However, according to the present embodiment, it is possible to eliminate leakage of the lubricating oil during such operations and prevent adhesion of the lubricating oil to the workpiece.

In the present embodiment, a strain detecting portion 40 that detects a load transmitted to the rod is provided, but the means for detecting a load transmitted to the rod is not limited thereto. In addition, when there is no need to detect a load, it is not necessary to provide a means for detecting a load.

### REFERENCE SIGNS LIST

10 Electric motor
20 Rotation-transmitting mechanism
21 First rotary shaft
22 First timing pulley
23 Timing belt
24 Second timing pulley
25 Second rotary shaft
26 Deep groove ball bearing
30 Cylinder portion
31 First tube portion
32 Second tube portion
33 Third rotary shaft
34 Reduction gear
35 Thrust angular ball bearing
36 Rod
37 Rod groove portion
40 Strain detecting portion
41 Fixing portion
42 Load receiving portion
43 Sensing portion
44, 45, 46 Hole
47 Strain gauge
50 Screw mechanism portion
51 Ball screw shaft
52 Ball
53 Ball screw nut
54 First seal
55 Second seal
56 Ball rolling portion
60a, 60b Bushing member
61 Base material
62 Hole
70 Key member
71, 72 Hole
100 Electrically driven cylinder

1. An electrically driven cylinder, comprising:
a screw mechanism portion that converts rotational motion of an electric motor into linear motion;
a rod that reciprocates by linear motion of the screw mechanism portion;
a bushing member that regulates swinging of the rod; and
a key member which is inserted into a rod groove portion provided along an axial direction of the rod and which regulates rotation of the rod;
a lubricant being sealed in the screw mechanism portion,
the bushing member having a plurality of holes in which a lubricant is embedded, and
the key member having a plurality of holes in which a lubricant is embedded.

2. The electrically driven cylinder according to claim 1, wherein the lubricant in the screw mechanism portion is a semi-solid and the lubricants of the bushing member and the key member are solids.
